(19) United States
(12) Patent Application Publication
(10) Pub. No.: US 2009/0257744 A1
(43) Pub. Date: Oct. 15, 2009

(54) TRANSCEIVER SYSTEM AND DATA TRANSMISSION METHOD

(76) Inventor: Hiroshi YAMAMOTO, Tokyo (JP)

Correspondence Address: NEC CORPORATION OF AMERICA, 6535 N. STATE HWY 161, IRVING, TX, 75039, US

(21) Appl. No.: 12/423,284

(22) Filed: Apr. 14, 2009

(30) Foreign Application Priority Data
Apr. 14, 2008 (JP) 2008-104850

(51) Int. Cl. H04B 10/08

(52) U.S. Cl. 398/22

(57) ABSTRACT

A transceiver system includes a transceiver; and a transceiver control apparatus. In the transceiver, a determining circuit determines whether a reception signal group including a transmission data is in a normal state or in an abnormal state. A control circuit reads the transmission data from a buffer section when a determination result indicates that the reception signal group is in the normal state, to generate a transmission instruction, and discards the transmission data when the determination result indicates that the reception signal group is in the abnormal state. A transmitting circuit generate a transmission signal based on the transmission instruction.

### INCORPORATION BY REFERENCE

The present patent application claims priority on convention based on Japanese Patent Application No. 2008-104850, filed Apr. 14, 2008. The disclosure thereof is incorporated herein by reference.

### TECHNICAL FIELD

The present invention relates to a transceiver and a data transmission method, and more particularly, to a wireless transceiver such as an optical transceiver and a data transmission method.

### BACKGROUND ART

In case of performing data communication between a communication network and a terminal by use of a radio signal or an optical signal, a transceiver is mounted on a terminal side for a data input/output port. The transceiver converts an electrical signal generated in the terminal into a wireless signal such as an optical signal to transmit it onto a communication network. Also, upon reception of a wireless signal from the communication network, the transceiver converts it into an electrical signal to output the electrical signal to the terminal.

Among such transceivers, an optical transceiver for conversion between an optical signal and an electrical signal requires decrease in size and increase in integration. Also, in case of the basis of a unified standard MSA (Multi Source Agreement), physical dimensions are defined.

In a manufacturing process of the optical transceiver, there are a number of steps in which soldering is performed. As the size of the transceiver is reduced, an object to be soldered is also reduced in size, and consequently a size of a chip component to be soldered and a distance between the components are decreased. An accuracy of manual soldering has a limitation, and therefore a generation rate of erroneous mounting is increased. Also, along with the decrease in size of a component, influence of noise is ready to undergo. For these reasons, a technique for preventing an optical transceiver from malfunctioning is required.

In conjunction with a data communication using an optical signal, Japanese Patent Application Publication (JP-P2000-36828A) discloses an optical subscriber system to realize voice communication and data communication simultaneously in parallel in a same PON system without complicated control to a station side.

In conjunction with a technique for preventing a malfunction, Japanese Patent Application Publication (JP-A-Heisei 9-162811) discloses a technique to resolve defective extinction and delay in light emission due to a difference between a temperature characteristic of a laser diode and a temperature characteristic of a circuit for controlling the drive of the laser diode.

In conjunction with a technique for preventing a malfunction, Japanese Patent Application Publication (JP-A-Heisei 5-75547) describes that when an input signal to an optical transmitter is disconnected, opened without input, or brought to an excessive DC signal having a high level or more of a rated input signal, the supply of a drive current from a semiconductor laser driving circuit to a semiconductor laser is blocked to inhibit the semiconductor laser from emitting output light.

### SUMMARY

Therefore, a subject matter of the present invention is to provide a transceiver system and a data transmission method, in which a malfunction can be prevented.

In an aspect of the present invention, a transceiver includes: a determining circuit configured to determine whether a reception signal group is in a normal state or in an abnormal state; a control circuit configured to receive the reception signal group, temporarily store a transmission data contained in the reception signal group in a buffer section, read the transmission data from the buffer section when a determination result by the determining circuit indicates that the reception signal group is in the normal state, generate a transmission instruction containing the transmission data, and discard the transmission data stored in the buffer section when the determination result by the determining circuit indicates that the reception signal group is in the abnormal state; and a transmitting circuit configured to generate a transmission signal based on the transmission instruction and transmit the transmission signal.

In another aspect of the present invention, a data transmission method includes: determining whether a reception signal group is in a normal state or in an abnormal state; receiving the reception signal group to temporarily store a transmission data included in the reception signal group in a buffer section; when a result of the determination indicates that the reception signal group is in the normal state, reading the transmission data from the buffer section and generating a transmission instruction including the transmission data; discarding the transmission data stored in the buffer section when the determination result indicates that the reception signal group is in the abnormal state; and transmitting a transmission signal based on the transmission instruction.

In still another aspect of the present invention, a transceiver system includes: a transceiver; and a transceiver control apparatus configured to generate and transmit a reception signal group to the transceiver. The transceiver includes a determining circuit configured to determine whether the reception signal group is in a normal state or in an abnormal state; a control circuit configured to receive the reception signal group, temporarily store a transmission data contained in the reception signal group in a buffer section, read the transmission data from the buffer section when a determination result by the determining circuit indicates that the reception signal group is in the normal state, generate a transmission instruction containing the transmission data, and discard the transmission data stored in the buffer section when the determination result by the determining circuit indicates that the reception signal group is in the abnormal state; and a transmitting circuit configured to generate a transmission signal based on the transmission instruction and transmit the transmission signal.

According to the present invention, a transceiver and a data transmission method are provided in which a malfunction can be prevented.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a block diagram illustrating an optical transceiver system according to a first exemplary embodiment of the present invention;

FIG. 2 is a block diagram illustrating the optical transceiver system according to a second exemplary embodiment of the present invention; and

FIG. 3 is a block diagram illustrating a wireless transceiver system according to a third exemplary embodiment of the present invention.

### EXEMPLARY EMBODIMENTS

Hereinafter, a transceiver system of the present invention such as an optical transceiver will be described with reference to the attached drawings.

### First Exemplary Embodiment

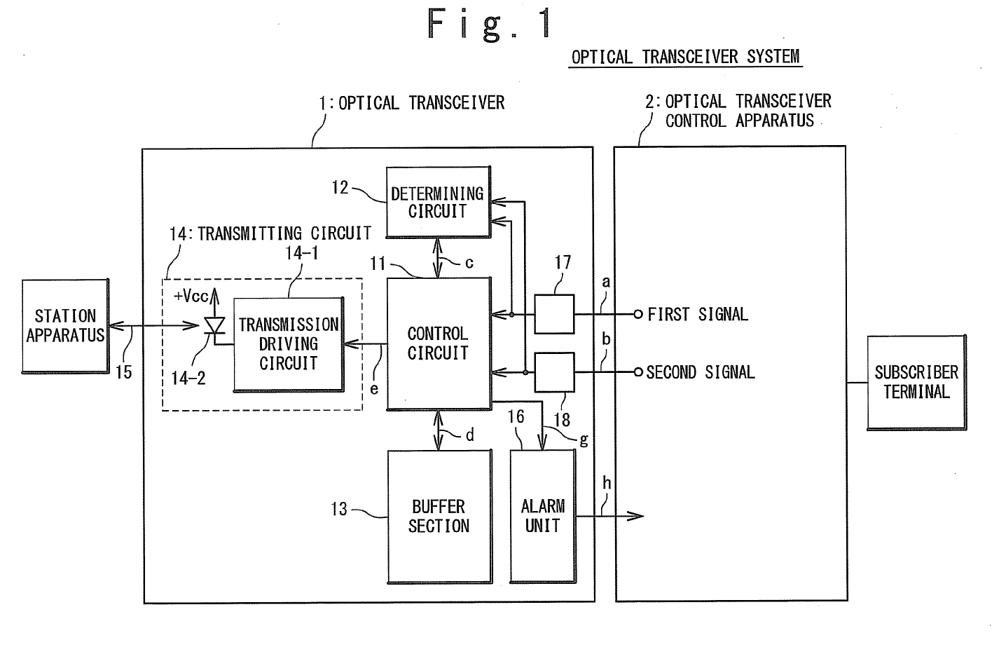

FIG. 1 is a block diagram schematically showing a configuration of an optical transceiver system according to a first exemplary embodiment of the present invention. The optical transceiver system is connected to a station apparatus through an optical fiber 15. The optical transceiver system is also connected to a subscriber terminal exemplified by a computer. The optical transceiver system is configured to perform conversions for data communication between the subscriber terminal and the station apparatus in a PON (Passive Optical Network) system. In the PON system, a plurality of subscriber terminals are accessibly connected to one station apparatus. The station apparatus allocates to each of the plurality of subscriber terminals, a time period or slot in which signal transmission is allowed. The time periods are allocated not to be overlapped among the plurality of subscriber terminals. Thus, it becomes possible for the station apparatus to identify from which of the subscriber terminals a signal has been transmitted. In such a PON system, if the optical transceiver malfunctions, a signal may be transmitted even for a time period in which signal transmission is not permitted. If the signal transmitted due to the malfunction is superposed on a signal transmitted from another subscriber terminal, the entire PON system may lose a function thereof. Accordingly, it is required that the malfunction of the optical transceiver system is more surely prevented.

The configuration of the optical transceiver system will be described in detail below. As illustrated in FIG. 1, the optical transceiver system includes an optical transceiver 1 and an optical transceiver control apparatus 2 for controlling the optical transceiver 1.

The optical transceiver control apparatus 2 is connected to the subscriber terminal. When receiving transmission data from the subscriber terminal, the optical transceiver control apparatus 2 generates a first signal a including the transmission data. Also, the optical transceiver control apparatus 2 outputs the first signal a to the optical transceiver 1. In addition, the optical transceiver control apparatus 2 generates a second signal b to output to the optical transceiver 1. The second signal b indicates whether a current time is within a data transmission permission period or a data transmission inhibition period. Although not shown, the optical transceiver control apparatus 2 can identify the data transmission permission period, on the basis of allocation data notified from the station apparatus.

The optical transceiver 1 includes a control circuit 11, a determining circuit 12, a buffer section 13, a transmitting circuit 14, an alarm unit 16, a first signal terminating circuit 17, and a second signal terminating circuit 18.

The first signal terminating circuit 17 is connected to the optical transceiver control apparatus 2. The first signal terminating circuit 17 supplies the first signal a from the optical transceiver control apparatus 2 to the determining circuit 12 and the control circuit 11 as an electrical signal. The second signal terminating circuit 18 is also connected to the optical transceiver control apparatus 2, and supplies the second signal b to the determining circuit 12 and the control circuit 11 as an electrical signal.

The determining circuit 12 determines whether the first signal a and the second signal b of a signal group are in a normal state or in an abnormal state. The determining circuit 12 outputs a result of the determination to the control circuit 11 by a determination signal c.

The buffer section 13 temporarily stores the transmission data, and may include a memory, delay circuit, and the like.

The control circuit 11 generates a transmission instruction e on the basis of the signal group of the first signal a and the second signal b, to output to the transmitting circuit 14. It should be noted that the control circuit 11 temporarily stores the transmission data included in the first signal a in the buffer section 13. Then, when the determination signal c received from the determining circuit 12 indicates that the signal group is in the normal state, the control circuit 11 reads the stored transmission data from the buffer section 13 to generate an electrical signal including the transmission data. The generated electrical signal is transferred to the transmitting circuit 14 as the transmission instruction e. On the other hand, when the determination signal c indicates that the signal group is in the abnormal state, the control circuit 11 discards the transmission data stored in the buffer section 13, and generates an alarm unit control signal g to output to the alarm unit 16.

The transmitting circuit 14 includes a transmission driving circuit 14-1 and a laser diode 14-2. The transmission driving circuit 14-1 is configured to apply power to the laser diode 14-2 to make the laser diode 14-2 emit a light beam. In response to the transmission instruction e that is the electrical signal, the transmission driving circuit 14-1 drives the laser diode 14-2 to emit the light beam. The laser diode 14-2 is connected to the optical fiber 15. A light beam emitted from the laser diode 14-2 is transmitted to the station apparatus side through the optical fiber 15 as an optical signal.

The alarm unit 16 generates an alarm output signal h in response to the alarm unit control signal g outputted from the control circuit 11, to transmit to the optical transceiver control circuit 11.

Next, an operation of the above-described optical transceiver system will be described.

First, it is assumed that the subscriber terminal generates a transmission data to be transmitted to the station apparatus. The generated transmission data is transmitted to the optical transceiver control apparatus 2. The optical transceiver control apparatus 2 generates the first signal a including the transmission data, to transmit to the optical transceiver 1. Also, the optical transceiver control apparatus 2 generates the second signal b indicating whether a present time is within a transmission permission period or in a transmission inhibition period, to output to the optical transceiver 1.

In the optical transceiver 1, the first signal a and the second signal b of the signal group are supplied to the control circuit 11 and the determining circuit 12. The control circuit 11 temporarily stores the transmission data included in the first signal a in the buffer section 13.

The determining circuit 12 determines whether the first signal a and the second signal b are in the normal state or in the abnormal state. Specifically, the determining circuit 12 compares a mark rate of a signal group of the first signal a and the second signal b with predetermined ranges, and determines that the signal group of signals is in the abnormal state when they are out of the ranges, respectively. Also, when the first signal a and the second signal b are in an indefinite range for a time period equal to or longer than a predetermined time period, the determining circuit 12 determines that the signal group of signals is in the abnormal states. It should be noted that the indefinite range is between a high level side threshold and a low level side threshold that are used for signal level determination. That is, when a time period in which the signals cannot be determined to be in the high level or the low level continues for a predetermined time period or longer, the determining circuit 12 determines the signal group to be in the abnormal state.

Also, in the PON system, the transmission permission period and the transmission inhibition period are periodically switched for one subscriber terminal. That is, if being in the normal state, a level of the second signal b is periodically switched to the other level. Accordingly, if the second signal b exhibits the same level for the predetermined time period or longer, the determining circuit 12 determines the signal to be in the abnormal state. Further, the determining circuit 12 monitors the voltage levels of the first signal a and the second signal b in consideration of noise. When instantaneous variations in the voltage levels due to noise are present, the determining circuit 12 determines the signals to be in the abnormal state. Still further, the determining circuit 12 monitors the voltage levels of the first signal a and the second signal b. When the voltage levels are out of a predetermined range, the determining circuit 12 determines the signals as overvoltage or insufficient amplitude to determine them to be in the abnormal state.

The determining circuit 12 generates the determination signal c indicating a result of the determination to transfer to the control circuit 11.

When the determination signal c indicates that the signal group is in the normal state, the control circuit 11 reads the transmission data stored in the buffer section 13. Then, the control circuit 11 generates a transmission instruction e including the read data. If the second signal b indicates that the present time is within a transmission permission period, the control circuit 11 immediately issues the transmission instruction e to the transmitting circuit 14. When the second signal b indicates that the present time is within the transmission inhibition period, the control circuit 11 issues the transmission instruction e to the transmitting circuit 14 after switching from the transmission inhibition period to the transmission permission period. In the transmitting circuit 14 having receiving the transmission instruction e, the transmission driving circuit 14-1 drives the laser diode 14-2 to generate an optical signal representing the transmission data. The generated optical signal is transmitted (outputted) to the station apparatus through the optical fiber 15.

On the other hand, when the determination signal c indicates that the signal group is in the abnormal state, the control circuit 11 discards the transmission data stored in the buffer section 13. Then, the control circuit 11 generates the alarm unit control signal g to output to the alarm unit 16. The alarm unit 16 generates an alarm output signal h in response to the alarm unit control signal g, to transfer it to the optical transceiver control apparatus 2. The optical transceiver control apparatus 2 further outputs the alarm output signal h to the subscriber terminal to notify to a user that the signal group is in the abnormal state.

According to the present exemplary embodiment, the control circuit 11 stores the transmission data included in a signal group (first and second signals) for the single terminal in the buffer section 13, and discards the transmission data in case of the detection of the signal group in the abnormal state. Consequently, the malfunction of the optical transceiver 1 is prevented.

Also, in this case, the transmission data is temporarily stored in the buffer section 13, and therefore it is not necessary to receive the signal group from the optical transceiver control apparatus 2 again, even if it takes time to determine whether the signal group is in the abnormal state or in the normal state.

Further, the optical transceiver 1 includes the alarm unit 16, and therefore if the signal group is in the abnormal state, the abnormal state can be notified to the optical transceiver control apparatus 2. Thus, it can be easily determined whether each of the optical transceiver 1 and the optical transceiver control apparatus 2 is in failure, and therefore a defective point can be easily identified upon occurrence of failure.

Still further, in a manufacturing process of the optical transceiver, the terminating circuit (17 or 18) may be mounted with a termination resistor by soldering. If the soldering of the termination resistor is inadequate, the resistor may be brought into an OPEN state or the like as time passes even if it is electrically normal upon the manufacturing. According to the present exemplary embodiment, even if the resistor is in a conductive state upon the manufacturing, and brought into the OPEN state after incorporated in the PON system, the control circuit 11 can prevent a malfunction, and therefore reliability of the entire PON system can be increased.

### Second Exemplary Embodiment

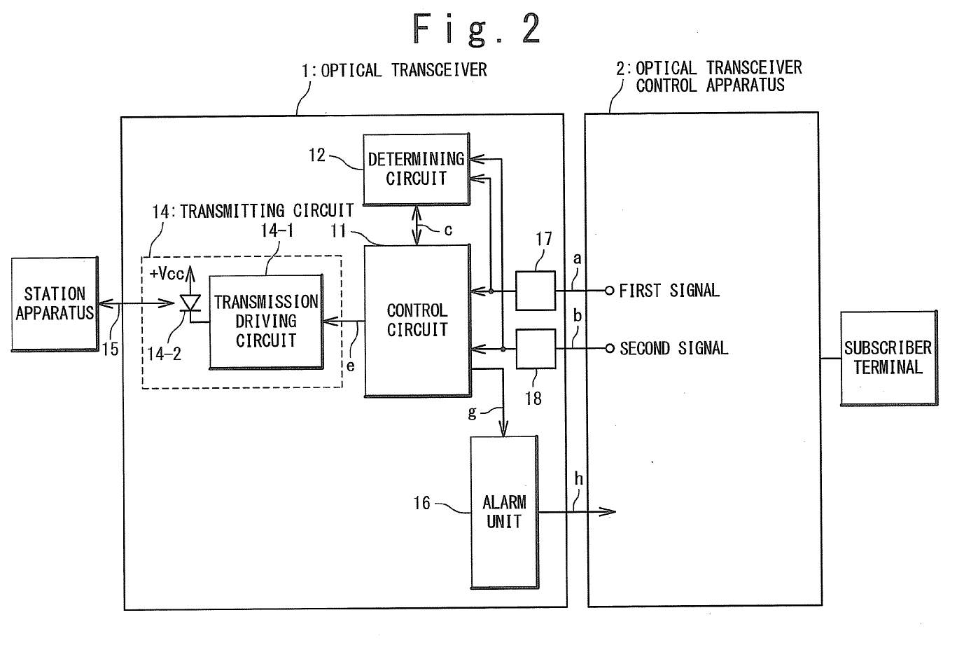

Next, a second exemplary embodiment of the present invention will be described. FIG. 2 is a block diagram illustrating an optical transceiver system according to the present exemplary embodiment. In the present exemplary embodiment, the buffer section 13 is omitted from the configuration of the first exemplary embodiment. The remaining components are the same as those in the first exemplary embodiment, and detailed description thereof is omitted.

In the present exemplary embodiment, if the second signal b indicates that the present time is within the transmission permission period, the control circuit 11 converts the first signal a into the transmission instruction e in real time to supply to the transmitting circuit 14. Accordingly, the transmitting circuit 14 emits the light beam in real time. However, if the control circuit 11 is received from the determining circuit 12, the determination signal c which indicates that the signal group is in the abnormal state, the control circuit 11 stops the issuance of the transmission instruction e at that time to stop the light beam emission.

According to the present exemplary embodiment, if the signal group is in the abnormal state, erroneous light emission may initially occur. However, the issuance of the transmission instruction is stopped on the basis of a determination result by the determining circuit 12. Accordingly, a period of the malfunction can be kept to the minimum.

### Third Exemplary Embodiment

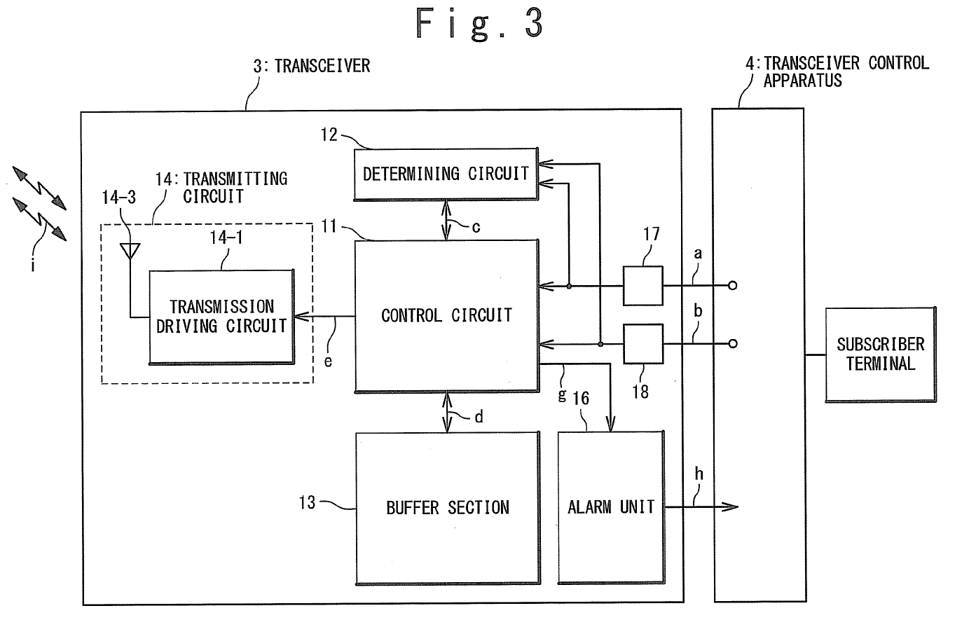

Subsequently, a third exemplary embodiment of the present invention will be described. FIG. 3 is a block diagram illustrating the wireless transceiver system according to the present exemplary embodiment. In the already-described exemplary embodiments, the optical transceivers each converting an electrical signal into an optical signal have been described. Meanwhile, in the wireless or radio transceiver of the present exemplary embodiment, an electrical signal is converted into a wireless or radio signal, which is then transmitted. That is, the wireless transceiver of the present exemplary embodiment is provided with an antenna 14-3 in the transmitting circuit 14. The other components and operations are the same as those in the first exemplary embodiment, and therefore detailed description thereof is omitted.

In the present exemplary embodiment, the transmission driving circuit 14-1 drives the antenna 14-3 to transmit the wireless signal upon reception of the transmission instruction e that is the electrical signal. Similarly to the first exemplary embodiment, even according to the present exemplary embodiment, transmission of the wireless signal due to malfunction is prevented if the reception signal group is in the abnormal state.

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A transceiver comprising:
a determining circuit configured to determine whether a reception signal group is in a normal state or in an abnormal state;
a control circuit configured to receive the reception signal group, temporarily store a transmission data contained in the reception signal group in a buffer section, read the transmission data from said buffer section when a determination result by said determining circuit indicates that the reception signal group is in the normal state, generate a transmission instruction containing the transmission data, and discard the transmission data stored in said buffer section when the determination result by said determining circuit indicates that the reception signal group is in the abnormal state; and
a transmitting circuit configured to generate a transmission signal based on the transmission instruction and transmit the transmission signal.

2. The transceiver according to claim 1, wherein the reception signal group and the transmission instruction are electrical signals, and
said transmitting circuit converts the transmission instruction into an optical signal to output as the transmission signal.

3. The transceiver according to claim 1, wherein the reception signal group and the transmission instruction are electrical signals, and
said transmitting circuit converts the transmission instruction into a radio signal to output as the transmission signal.

4. The transceiver according to claim 1, wherein the transmission data contained in the reception signal group is generated in a subscriber terminal in a PON (Passive optical network) system, and
said transmitting circuit transmits a transmission signal from said subscriber terminal to a station apparatus in the PON system through an optical fiber.

5. The transceiver according to claim 1, further comprising:
an alarm unit configured to generate an alarm signal,
wherein said control circuit generates an alarm unit control signal to output to said alarm unit, when the determination result by said determining circuit indicates that the reception signal group is in the abnormal state, and
said alarm unit generates the alarm signal in response to said alarm unit control signal.

6. The transceiver according to claim 1, wherein said determining circuit determines that the reception signal group is in the abnormal state, when a mark rate of the reception signal group is out of a predetermined standard range.

7. The transceiver according to claim 1, wherein the reception signal group contains a first signal including the transmission data and a second signal indicating whether a current time is within a transmission permission period or a transmission inhibition period.

8. The transceiver according to claim 7, wherein said determining circuit determines that the reception signal group is in the abnormal state, when the second signal is indefinite for a period equal to or longer than a predetermined time period.

9. The transceiver according to claim 1, wherein said determining circuit determines whether or not the reception signal group is in the normal state or in the abnormal state, based on the voltage levels of the reception signal group.

10. A data transmission method comprising:
determining whether a reception signal group is in a normal state or in an abnormal state;
receiving the reception signal group to temporarily store a transmission data included in the reception signal group in a buffer section;
when a result of the determination indicates that the reception signal group is in the normal state, reading the transmission data from said buffer section and generating a transmission instruction including the transmission data;
discarding the transmission data stored in said buffer section when the determination result indicates that the reception signal group is in the abnormal state; and
transmitting a transmission signal based on the transmission instruction.

11. The data transmission method according to claim 10, wherein the reception signal group and the transmission instruction are electrical signals, and
said transmitting comprises:
converting the transmission instruction into an optical signal to output as the transmission signal.

12. The data transmission method according to claim 10, wherein the reception signal group and the transmission instruction are electrical signals, and
said transmitting comprises:
converting the transmission instruction into a radio signal to output as the transmission signal.

13. The data transmission method according to claim 10, further comprising:
generating the reception signal group based on signals generated in a subscriber terminal in PON (Passive optical network) system,
wherein said transmitting comprises:
transmitting the transmission signal from said subscriber terminal to a station apparatus in said PON through an optical fiber cable.

14. The data transmission method according to claim 10, further comprising:
generating an alarm unit control signal when the determination result indicates that the reception signal group is in the abnormal state; and
driving an alarm unit in response to the alarm unit control signal.

15. The data transmission method according to claim 10, wherein said determining comprises:
determining that the reception signal group is in the abnormal state, when a mark rate of the reception signal group is out of a predetermined range.

16. The data transmission method according to claim 10, wherein the reception signal group contains a first signal including the transmission data and a second signal indicating whether or not a present time is within a transmission permission period or not a transmission inhibition period.

17. The data transmission method according to claim 16, wherein said determining comprises:
determining that the reception signal group is in the abnormal state when a voltage level of the second signal is indefinite for a period equal to or longer than a predetermined time period.

18. The data transmission method according to claim 10, wherein said determining comprises:
determining whether the reception signal group is in the normal state or in the abnormal state, based on the voltage level of the reception signal group.

19. A transceiver system comprising:
a transceiver; and
a transceiver control apparatus configured to generate and transmit a reception signal group to said transceiver,
wherein said transceiver comprises:
a determining circuit configured to determine whether the reception signal group is in a normal state or in an abnormal state;
a control circuit configured to receive the reception signal group, temporarily store a transmission data contained in the reception signal group in a buffer section, read the transmission data from said buffer section when a determination result by said determining circuit indicates that the reception signal group is in the normal state, generate a transmission instruction containing the transmission data, and discard the transmission data stored in said buffer section when the determination result by said determining circuit indicates that the reception signal group is in the abnormal state; and
a transmitting circuit configured to generate a transmission signal based on the transmission instruction and transmit the transmission signal.

20. The transceiver system according to claim 19, wherein the reception signal group and the transmission instruction are electrical signals, and
said transmitting circuit converts the transmission instruction into an optical signal to output as the transmission signal.

21. The transceiver system according to claim 19, wherein the reception signal group and the transmission instruction are electrical signals, and
said transmitting circuit converts the transmission instruction into a radio signal to output as the transmission signal.

22. The transceiver system according to claim 19, wherein the transmission data contained in the reception signal group is generated in a subscriber terminal in a PON (Passive optical network) system, and
said transmitting circuit transmits a transmission signal from said subscriber terminal to a station apparatus in the PON system through an optical fiber.

23. The transceiver system according to claim 19, further comprising:
an alarm unit configured to generate an alarm signal,
wherein said control circuit generates an alarm unit control signal to output to said alarm unit, when the determination result by said determining circuit indicates that the reception signal group is in the abnormal state, and
said alarm unit generates the alarm signal in response to said alarm unit control signal.

24. The transceiver system according to claim 19, wherein said determining circuit determines that the reception signal group is in the abnormal state, when a mark rate of the reception signal group is out of a predetermined standard range.

25. The transceiver system according to claim 19, wherein the reception signal group contains a first signal including the transmission data and a second signal indicating whether a current time is within a transmission permission period or a transmission inhibition period.

26. The transceiver system according to claim 25, wherein said determining circuit determines that the reception signal group is in the abnormal state, when the second signal is indefinite for a period equal to or longer than a predetermined time period.

27. The transceiver system according to claim 19, wherein said determining circuit determines whether or not the reception signal group is in the normal state or in the abnormal state, based on the voltage levels of the reception signal group.
